(19) United States
(12) Patent Application Publication
(10) Pub. No.: US 2021/0246005 A1
(43) Pub. Date: Aug. 12, 2021

(54) Lift Truck Hoist Attachment

(71) Applicant: RAM Industries, Roanoke, IN (US)

(72) Inventor: Robert Mutton, Roanoke, IN (US)

(73) Assignee: RAM Industries, Roanoke, IN (US)

(21) Appl. No.: 17/164,906

(22) Filed: Feb. 2, 2021

Related U.S. Application Data
(60) Provisional application No. 62/971,492, filed on Feb. 7, 2020.

(51) Int. Cl. B66F 9/12; B66D 3/24; B66D 3/26

(52) U.S. Cl. CPC B66F 9/12; B66D 3/26; B66D 3/24

(57) ABSTRACT

A lower mast is attached to a base having fork pockets, and is pivotal between vertical and horizontal positions. A lower mast brace assembly has a receiver configured to receive the lower mast as it is moved into the generally vertical position, and to retain it there. An upper mast having a hoist at its upper end slides into the lower mast. The upper mast has a dogleg that offsets the hoist forward of the centerline of the lower mast. A hook is attached to the lower mast brace assembly near the receiver. The hinge, the lower mast brace assembly, the dogleg of the upper mast, and the hook are arranged so that the hoist may be used to pull the mast from the horizontal position to the vertical position. A combination limit switch, buffer, and vertical shutoff switch may be attached to the upper end of the upper mast.

### CROSS-REFERENCE TO RELATED APPLICATIONS

The present application claims priority to U.S. Provisional No. 62/971,492 filed Feb. 7, 2020, the entire contents of all of which are herein incorporated by reference.

### BACKGROUND

### Field of Invention

Embodiments of the present invention described herein generally relate to a Lift Truck Tent Hoist Attachment. The Lift Truck Tent Hoist Attachment is designed as a self-contained collapsible boom or mast assembly usable with a forklift or other piece of equipment that is provided with forks. The Lift Truck Tent Hoist Attachment allows for lifting lightweight loads to significantly increased heights over the normal vertical reach of the forklift or other piece of equipment that is provided with forks.

### Related Art

Rental agencies often rent large tents for events such as parties, celebrations, festivals, sporting events, corporate events, concerts, and the like. Often, these tents are pole tents that are raised by securing at least a portion of the perimeter of the tent, and raising the center poles from underneath. In this way, the tent may be raised entirely by individuals working from ground level. However, pole tents have a drawback in that the center poles present an obstacle in the occupied area beneath the tent, along with guide ropes around the perimeter of the tent. In a worst case scenario, such center poles may even be damaged or knocked out from underneath the tent. Furthermore, pole tents are not engineered to withstand significant snow or wind loads. To overcome these deficiencies, rental agencies have begun to provide “clear span” structural tents, which may otherwise be referred to as structurally engineered tents or free standing tents. A clear span structural tent, structurally engineered tent, or free standing tent is essentially a free standing structure made out of aluminum tubing or other rigid material with a vinyl canopy secured over the top of the structure. The top of the structure is typically made of braced rafters or simple trusses. Because the vinyl canopy lies over the top of the rafters or roof trusses, or is kedered through channels in the top of the rafters or roof trusses, no center poles are needed, and the span between the side and ends of the tent remains clear of obstructions. The tent is then anchored through the baseplates of the legs by bolting, staking, or ballasting.

A difficulty involved with clear span tents is the fact that the rafters or simple trusses, along with the side legs, must be lifted and pivoted into a straight up position when the structure is being assembled. In order to maintain balance during lifting, the rafters or simple trusses must generally be lifted from their center point. Because the rafters or simple trusses are typically peaked at their center point, the lifting point is often a long way up vertically at the point of installation, often exceeding twenty feet. In order to set up clear span tents, therefore, rental agencies are required to provide lifting equipment at the installation site. Often, rental agencies use a portable crane, telehandler, or similar piece of equipment, which must be transported separately to the installation site for this purpose. These machines are often expensive, heavy, and rated far in excess of the actual lifting weight capacity that is actually needed. Additionally, such equipment often requires specially licensed personnel to operate.

Accordingly, there is an unmet need for an easily transportable lightweight lifting apparatus, which may be used for non-limiting example by rental agencies to erect clear span structural tents.

### SUMMARY

Embodiments described herein relate to a Lift Truck Tent Hoist Attachment. The Lift Truck Tent Hoist Attachment is designed for the purpose of erecting clear span structural tents, structurally engineered tents, or free standing tents, while requiring a minimum amount of specialized heavy equipment to be transported to the installation site. However, this recited purpose is exemplary, and is not to be considered limiting in any way, as embodiments of the Lift Truck Tent Hoist Attachment may be used for various lightweight vertical lifting purposes. For further non-limiting examples, embodiments of the Lift Truck Tent Hoist Attachment may be used to lift wood or steel rafters and beams in building industries, or to lift and install poles into holes in the ground.

The Lift Truck Tent Hoist Attachment may be embodied as a self-contained collapsible boom or mast assembly usable with, for non-limiting example, a fork truck. Specifically, embodiments of the Lift Truck Tent Hoist Attachment may be provided with a base having fork pockets that attaches to any fork truck, skid-steer loader, Bobcat, articulating loader, piggyback loader, telehandler, tractor, or other piece of equipment that is provided with forks. The base may be provided with safety chains to secure the Lift Truck Tent Hoist Attachment to the lift truck or other equipment having forks. Embodiments of the Lift Truck Tent Hoist Attachment may further be provided with a lower mast, an upper mast, and one or more intermediate mast extensions that may easily be assembled by hand, along with a hoist that is attached to the upper end of the upper mast. In this way, embodiments of the Lift Truck Tent Hoist Attachment allow for lifting lightweight loads to significantly increased heights, for non-limiting example up to 21 feet above the maximum vertical position of the forks.

The Lift Truck Tent Hoist Attachment allows for compact shipment, for example easily fitting inside of most box trucks. Yet it may be assembled and disassembled from ground level by one or two persons. In order to facilitate this, the lower mast is connected to the base by way of a pivot hinge, so that the lower mast can be leaned forward for the purpose of attaching and detaching the upper mast and any intermediate mast extensions. The upper mast is slidably engageable with the lower mast, and with any intermediate mast extensions. The intermediate mast extensions are slidably engageable with the lower mast. A kick stand is connected to the lower mast to improve and simplify assembling and disassembling the Lift Truck Tent Hoist Attachment. Each of the lower mast, the intermediate mast extensions, and the upper mast may be provided with attached handles for easy lifting and handling. The Lift Truck Tent Hoist Attachment may be provided with a welded hook on its main frame assembly for the purpose of attaching the hoist cable. The hoist may then be used to raise or lower the mast on its hinge for assembling, disassembling, and adding additional intermediate mast extensions.

The hoist itself may be a 12-volt self-contained electric one ton to 2500 pound hoist that is connected to the upper end of the upper hoist. The hoist may be electrically connected to a battery box mounted to the base of the Lift Truck Tent Hoist Attachment. The hoist may be remote controlled by a handheld remote from up to 100 feet away. A metal guard may adjoin or encompass the hoist, in order to protect the hoist and its motor from impact damage. The hoist may be provided with a crane scale having an alarm to signal the operator of any weight overload. The hoist may further be provided with a cable tensioner to keep the hoist cable tight on the hoist spool. The hoist may further be provided with an automatic shut-off limit switch that will shut off the hoist when it is retracting, in order to keep from over-retracting the hoist cable and pulling the hook into the hoist motor.

In another non-limiting exemplary embodiment, the hoist may be provided with a combination limit switch, buffer, and vertical shutoff switch. The combination limit switch, buffer, and vertical shutoff switch is provided with a fair lead assembly that is attached to the hoist mount and/or hoist guard by way of fair lead mounting posts. The fair lead assembly is able to travel up and down along the fair lead mounting posts in a direction approximately tangent to the cable spool of the hoist. A fair lead spring is positioned over each fair lead mounting post, so that the fair lead assembly is forcibly biased toward the ends of the fair lead mounting posts. The fair lead assembly is retained to the fair lead mounting posts by bolts of larger head diameter than the holes of the fair lead assembly that go over the fair lead mounting posts.

A high limit switch, which may in one non-limiting exemplary embodiment be a reversing solenoid, adjoins the fair lead assembly, so that a high limit switch arm connected to the high limit switch contacts the fair lead assembly proximate to the spool of the hoist. As the hoist winds up the hoist cable, a cable buffer comes into contact with the fair lead assembly at or near the end of travel of the hoist cable. The cable buffer will not pass through the fair lead assembly, so that the fair lead assembly begins to compress the fair lead springs. As the fair lead assembly begins to travel along the fair lead mounting posts, the high limit switch arm causes the high limit switch to shut off the hoist. However, the hoist has significant rotational inertia, so that the hoist cable continues to withdraw for an inch or two. This additional motion is accommodated by the further compression of the fair lead springs, thereby preventing breakage of the hoist cable or other components of the Lift Truck Tent Hoist Attachment. In one non-limiting exemplary embodiment, the fair lead springs may be 300 pound per inch, three inch coil springs.

If embodied as a reversing solenoid, the high limit switch may in some but not all embodiments function to reverse the hoist momentarily, in order to decompress the fair lead springs. The high limit switch, whether or not embodied as a reversing solenoid, and the hoist, being connected to each other, are further operably connected to a handheld remote. The handheld remote and the high limit switch work in conjunction to control the hoist in raising and lowering the hoist cable by winding or unwinding the hoist cable. The reversing solenoid may be between 250 amps and 500 amps in capacity, preferably 500 amps in capacity. The fair lead assembly may be provided with rollers, in order to guide the hoist cable onto the hoist spool.

A further functionality provided by the combination limit switch, buffer, and vertical shutoff switch is the off-vertical cutoff functionality. The Lift Truck Tent Hoist Attachment is meant to lift fairly light loads, such as the braced rafters or simple trusses of clear-span tents, in a substantially directly vertical direction. Because of the considerable additional vertical height provided by the Lift Truck Tent Hoist Attachment, it is important that the lift direction remains substantially vertical, and that minimal longitudinal or lateral forces be applied, particularly in the forward direction. In order to prevent this, the combination limit switch, buffer, and vertical shutoff switch may provide the aforementioned off-vertical cutoff functionality.

Specifically, the fair lead assembly is not only able to travel along the length of the fair lead mounting posts, but is also able to rock forward and rearward. This rocking capability may be the result of slotted holes where the fair lead assembly connects to the fair lead mounting posts, and/or may simply be a result of sufficient clearance between the holes in the fair lead assembly and the fair lead mounting posts. In any case, if the load being lifted by the hoist cable reaches between about 20 and 30 degrees from vertical, particularly in the forward direction, sufficient travel is imparted to the high limit switch arm that the high limit switch, whether or not embodied as a reversing solenoid, is triggered, which then shuts off the hoist, and/or reverses the hoist momentarily. This off-vertical cutoff functionality further protects against tipping the lift truck and Lift Truck Tent Hoist Attachment.

As further protection against breakage of the hoist cable or other components of the Lift Truck Tent Hoist Attachment, the hoist cable may be provided with a cable buffer spring. The cable buffer spring is arranged over the hoist cable between the cable buffer and the jay hook. In this way, when the cable buffer contacts the fair lead assembly of the combination limit switch, buffer, and vertical shutoff switch, and the high limit switch is triggered, additional travel is provided by the cable buffer spring in the event that the amount of travel provided by the fair lead springs is insufficient to compensate for the rotational inertia of the hoist and any lag time of the high limit switch. It is noted that the compression force of the cable buffer spring is chosen to be at least as stiff, in this case being 700 pounds per inch and 4½″ long, as the compression force of the fair lead springs. This ensures that the fair lead assembly of the combination limit switch, buffer, and vertical shutoff switch initially travels sufficiently to trigger the high limit switch.

It again emphasized that the present invention is conceived to be used by properly trained personnel for the directly vertical lifting of lightweight loads being a small fraction of the rated lifting capacity of the lift truck or other equipment having forks. It is not intended for heavy loads even within the rated lifting capacity of the lift truck or other equipment having forks, nor is it intended for pulling, towing, or lateral loads.

According to one embodiment of the Lift Truck Tent Hoist Attachment, a lower mast is attached to a base having fork pockets by way of a hinge, and is pivotal between a generally vertical position and a generally horizontal position. A lower mast brace assembly is attached to the base and has a receiver configured to receive the lower mast as it is moved into the generally vertical position, and to retain the lower mast once the lower mast is in the generally vertical position. An upper mast is slidably engageable with and dis-engageable from the lower mast. A hoist is attached to the upper end of the upper mast. The upper mast has a dogleg that offsets the hoist forward of the centerline of the lower mast. A hook is attached to the lower mast brace assembly near the receiver. The hinge, the lower mast brace assembly, the dogleg of the upper mast, and the hook are arranged so that a cable connected to the hoist may be used to pull the lower mast and the upper mast from the generally horizontal position to the generally vertical position.

According to another embodiment of the Lift Truck Tent Hoist Attachment, a lower mast is attached to a base having fork pockets by way of a hinge, and is pivotal between a generally vertical position and a generally horizontal position. A lower mast brace assembly is attached to the base and has a receiver configured to receive the lower mast as it is moved into the generally vertical position, and to retain the lower mast once the lower mast is in the generally vertical position. An upper mast is slidably engageable with and dis-engageable from the lower mast. A hoist is attached to the upper end of the upper mast. A combination limit switch, buffer, and vertical shutoff switch is attached to the upper end of the upper mast and is connected to the hoist.

According to yet another embodiment of the Lift Truck Tent Hoist Attachment, a combination limit switch, buffer, and vertical shutoff switch is provided for use with a hoist. A fair lead assembly is attached to a mounting surface by way of fair lead mounting posts, and is configured to travel up and down along the fair lead mounting posts in a direction approximately tangent to the cable spool of the hoist. Fair lead springs are positioned over the fair lead mounting posts, and are arranged to forcibly bias the fair lead assembly toward the ends of the fair lead mounting posts. A high limit switch has a high limit switch arm configured to be actuated by the fair lead assembly when it travels upwards along the fair lead mounting posts. The high limit switch is configured to switch off the hoist when the high limit switch arm is actuated by the fair lead assembly. A cable buffer is attached near the end of the cable of the hoist and is configured to engage the fair lead assembly when the cable of the hoist is nearly rewound. Upon engagement with the fair lead assembly, the cable buffer causes the fair lead assembly to travel upwards along the fair lead mounting posts as the hoist further winds the cable.

### DESCRIPTION OF THE DRAWINGS

The above-mentioned and other features of embodiments of the Lift Truck Tent Hoist Attachment, and the manner of their working, will become more apparent and will be better understood by reference to the following description of embodiments of the Lift Truck Tent Hoist Attachment taken in conjunction with the accompanying drawings, wherein:

FIG. 1 is a partial front view of a first embodiment of the Lift Truck Tent Hoist Attachment of the present invention, as described herein;

FIG. 2 is a left hand side view of the first embodiment of the Lift Truck Tent Hoist Attachment of the present invention, as described herein;

FIG. 3 is a top view of the first embodiment of the Lift Truck. Tent Hoist Attachment of the present invention, as described herein;

FIG. 4 is a side view of an intermediate mast extension of the first embodiment of the Lift Truck Tent Hoist Attachment of the present invention, as described herein;

FIG. 5 is a side view of an upper mast and hoist assembly of the first embodiment of the Lift Truck Tent Hoist Attachment of the present invention, as described herein;

FIG. 6A is a right hand side view of the first embodiment of the Lift Truck Tent Hoist Attachment of the present invention, as described herein;

FIG. 6B is a side view of an upper mast of the first embodiment of the Lift Truck Tent Hoist Attachment of the present invention, as described herein;

FIG. 6C is a front view of an intermediate mast extension of the first embodiment of the Lift Truck Tent Hoist Attachment of the present invention, as described herein;

FIG. 7 is a top right isometric view of the first embodiment of the Lift Truck Tent Hoist Attachment of the present invention, as described herein;

FIG. 8 is a front view of the first embodiment of the Lift Truck Tent Hoist Attachment of the present invention, as described herein;

FIG. 9 is a top right isometric view of the first embodiment of the Lift Tack Tent Hoist Attachment of the present invention, as described herein;

FIG. 10 is a bottom rear isometric view of the first embodiment of the Lift Truck Tent Hoist Attachment of the present invention in use, as described herein;

FIG. 11 is a partial perspective view of the first embodiment of the Lift Truck Tent Hoist Attachment of the present invention in use, as described herein;

FIG. 12 is a top left isometric view of the first embodiment of the Lift Truck Tent Hoist Attachment of the present invention, as described herein;

FIGS. 13, 14, and 15 are top right isometric views of a second embodiment of the Lift Truck Tent Hoist Attachment of the present invention, as described herein;

FIG. 16 is a partial perspective view of the second embodiment of the Lift Truck Tent Hoist Attachment of the present invention, as described herein;

FIG. 17 is a partial bottom right side perspective view of a combination limit switch, buffer, and vertical shutoff switch of an embodiment of the Lift Truck Tent Hoist Attachment of the present invention, as described herein;

FIG. 18 is a partial bottom front right side perspective view of a combination limit switch, buffer, and vertical shutoff switch of an embodiment of the Lift Truck Tent Hoist Attachment of the present invention, as described herein;

FIG. 19 is a partial bottom right side perspective view of a combination limit switch, buffer, and vertical shutoff switch of an embodiment of the Lift Truck Tent Hoist Attachment of the present invention, as described herein;

FIG. 20 is an inverted partial bottom right side perspective view of a combination limit switch, buffer, and vertical shutoff switch of an embodiment of the Lift Truck Tent Hoist Attachment of the present invention, as described herein; and

FIG. 21 is a front perspective view of the second embodiment of the Lift Truck Tent Hoist Attachment of the present invention attached to a lift truck, as described herein.

Corresponding reference numbers indicate corresponding parts throughout the several views. The exemplifications set out herein illustrate embodiments of the Lift Truck Tent Hoist Attachment, and such exemplifications are not to be construed as limiting the scope of the claims in any manner.

### DETAILED DESCRIPTION

The following detailed description and appended drawing describe and illustrate various exemplary embodiments of the invention. The description and drawings serve to enable one skilled in the art to make and use the invention, and are not intended to limit the scope of the invention in any manner. In respect of the methods disclosed and illustrated, the steps presented are exemplary in nature, and thus, the order of the steps is not necessary or critical.

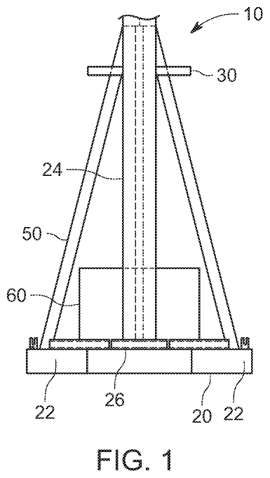

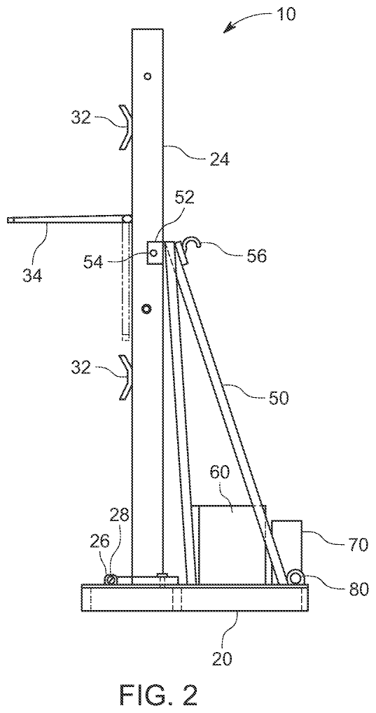

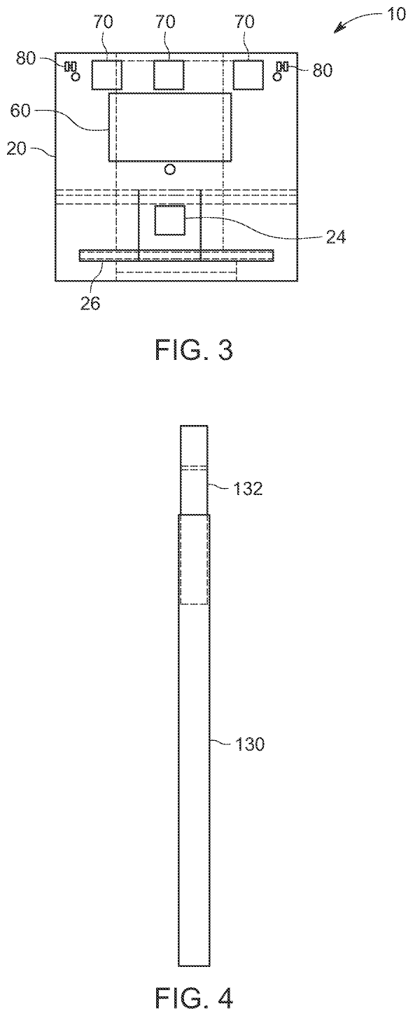

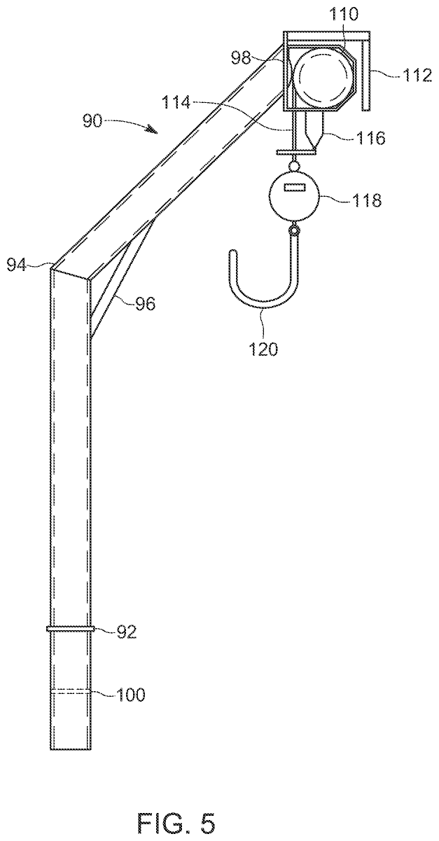

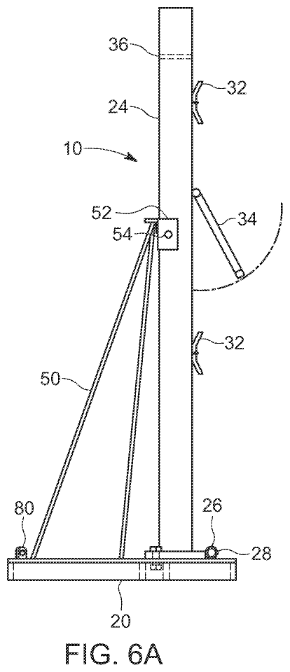

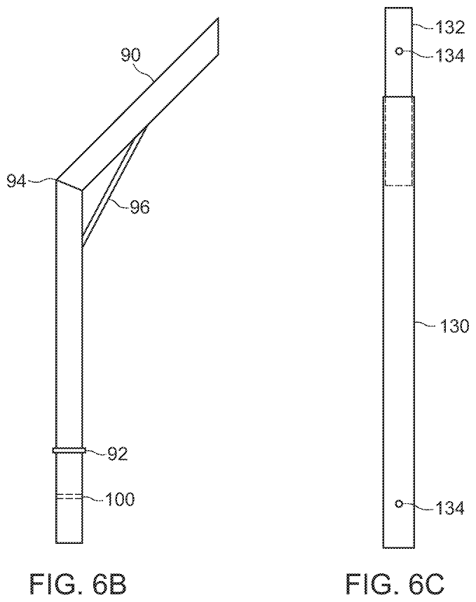

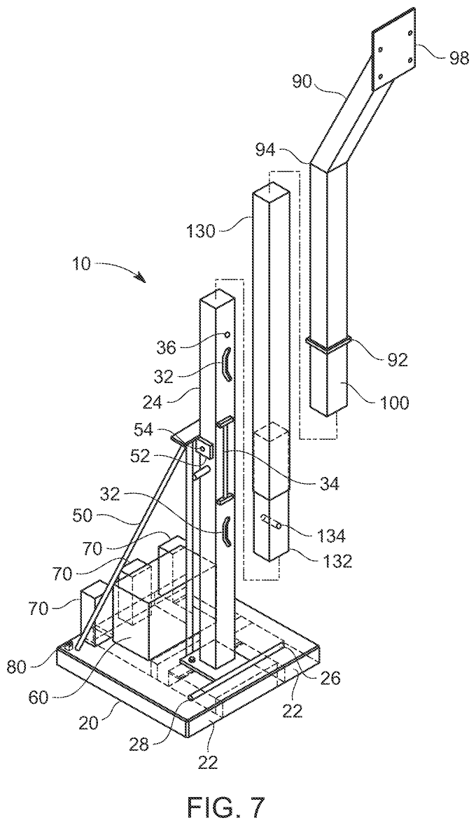

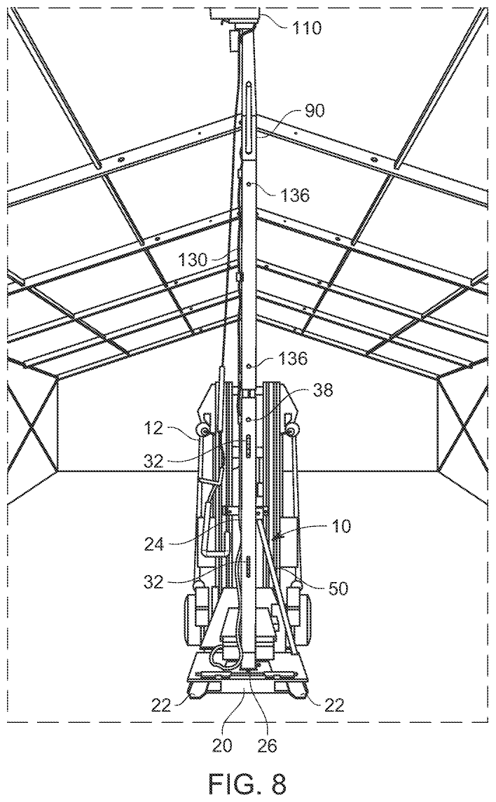

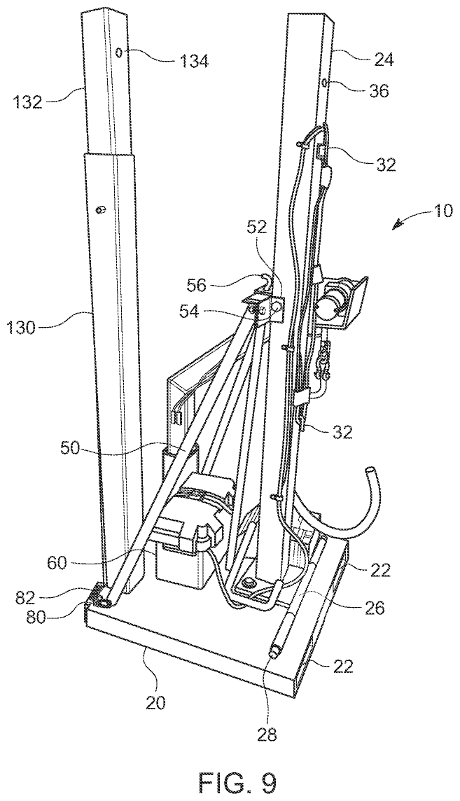

Turning now to FIGS. 1 through 7, a first embodiment of the Lift Truck Tent Hoist Attachment 10 is shown having a base 20 and a lower mast 24 connected to the base 20 by way of a lower mast pivot hinge 26. The base 20 is provided with two fork pockets 22 configured to receive the forks of a forklift (not shown) or other equipment having forks. The base 20 is further provided with a lower mast brace assembly 50 having a receiver 52. The lower mast brace assembly 50 is arranged so that at least one support strut is oriented generally vertically and proximate to the lower mast, and so that at least one support strut is oriented at an angle extending rearward from the receiver 52. When the lower mast 24 is in its vertical position, it engages with the receiver 52 and is held in place by a brace pin 54. The Lift Truck Tent Hoist Attachment 10 also has an upper mast 90 and one or more intermediate mast extensions 130. The upper mast 90 is slidably engageable with the lower mast 24 and with the one or more intermediate mast extensions 130, which one or more intermediate mast extensions 130 are also slidably engageable with the lower mast 24.

In order to assemble the one or more intermediate mast extensions 130 and/or the upper mast 90 to the lower mast 24 of the Lift Truck Tent Hoist Attachment 10, the lower mast 24 may be pivoted about the pivot hinge pin 28 of the lower mast pivot hinge 26 to a generally horizontal position. To facilitate this, the lower mast 24 may be provided with a lower mast handle 30. Further, a kick stand 34 may be attached to the lower mast 24, in order to hold the lower mast 24 up from the ground and in the generally horizontal position. Once the lower mast 24 is in the generally horizontal position, any intermediate mast extension 130 to be used may be slidably engaged with the lower mast 24 so that the extension insert 132 slides into the lower mast 24 until the lower mast retainer pin hole 36 and the extension retainer pin hole 134 overlap, and a lower mast retainer pin 38 (not shown in FIGS. 1 through 7) is inserted therein. The upper mast 90 may then be slidably engaged with the intermediate mast extension 130, or with the lower mast 24 if no intermediate mast extension 130 is to be used, until the stop ledge 92 abuts the upper end of the intermediate mast extension 130 or upper end of the lower mast 24 as applicable. The upper mast retainer pin hole 100 then overlaps another extension retainer pin hole 134, or the lower mast retainer pin hole 36 as applicable, and an extension retainer pin 136 (not shown in FIGS. 1 through 7) is inserted therein.

The upper mast 90 is provided with a dogleg 94, a dogleg brace 96, and a hoist mount 98 at the upper end of the upper mast 90. A hoist 110 is attached to the hoist mount 98, and may be protected by a hoist guard 112. The hoist 110 is provided with a hoist cable 114 and jay hook 120 for lifting. The hoist 110 may further be provided with a high limit switch 116 to prevent over-retraction of the hoist cable 114, and a crane scale or overload alarm 118 to notify an operator of a weight overload condition. In order to raise the assembled lower mast 24, upper mast 90, and any intermediate mast extensions 130, a welded hook 56 may be attached to the lower mast brace assembly 50. In use, the jay hook 120 may be engaged to the welded hook 56, and the hoist 110 may then be used tea pull the assembled lower mast 24, upper mast 90, and any intermediate mast extensions 130 to the vertical position. The arrangement of the welded hook 56 being attached to the lower mast brace assembly 50 proximate to the receiver 52, and of the dogleg 94 in the upper mast 90 offsetting the hoist 110 from the centerline of the lower mast 24, facilitates the use of the hoist 110 to pull the assembled lower mast 24, upper mast 90, and any intermediate mast extensions 130 to the vertical position.

The lower mast 24 may further be provided with power cord cleats 32 to facilitate storage of any power and/or remote controller cords. The base 20 may further be provided with a battery box 60 to provide electrical power for the hoist 110. Shackles or cleaves 80 may be attached to the corners of the base 20, so that a chain (not shown) may be used to secure the Lift Truck Tent Hoist Attachment 10 to a forklift or other equipment having forks. Finally, extension holders 70 may be attached to the base 20 for the purpose of holding the upper mast 90 and any intermediate mast extensions 130 during transport or storage.

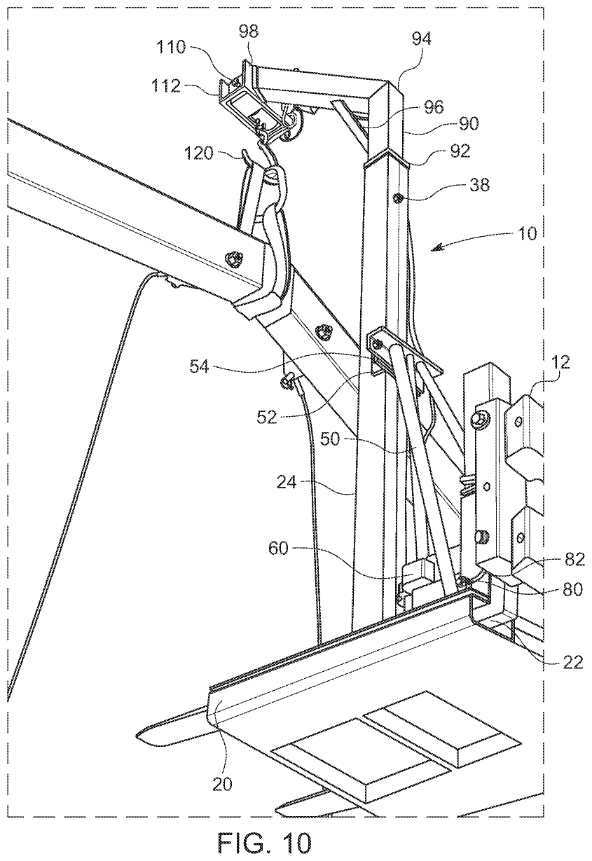

Turning now to FIG. 8, an embodiment of the Lift Truck Tent Hoist Attachment 10 is shown attached to a forklift 12, with the forks of the forklift 12 inserted into the fork pockets 22 of the base 20. The lower mast 24, upper mast 90, and an intermediate mast extension 130 have been assembled and raised to a vertical position about the lower mast pivot hinge 26. The lower mast 24 is engaged with the lower mast brace assembly 50. A lower mast retainer pin 38 retains the intermediate mast extension 130 to the lower mast 24, and an extension retainer pin 136 retains the upper mast 90 to the intermediate mast extension 130. Power cord cleats 32 are visible, and the hoist 110 may be used to vertically raise lightweight loads such as the rafters or simple trusses shown.

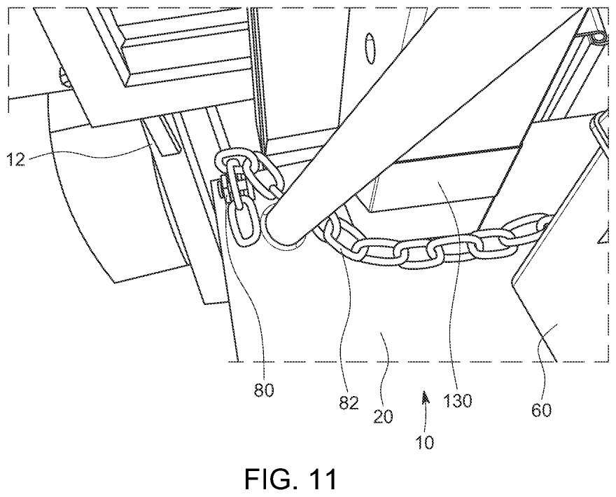

Turning now to FIG. 9, an embodiment of the Lift Truck Tent Hoist Attachment 10 is shown again having a base 20 and a lower mast 24 connected to the base 20 by way of a lower mast pivot hinge 26. The base 20 is again provided with two fork pockets 22 configured to receive the forks of a forklift (not shown) or other equipment having forks. The base 20 is again provided with a lower mast brace assembly 50 having a receiver 52. When the lower mast 24 is in its vertical position, it again engages with the receiver 52 and is held in place by a brace pin 54. The Lift Truck Tent Hoist Attachment 10 again has an upper mast 90 and one or more intermediate mast extensions 130. The upper mast 90 is slidably engageable with the lower mast 24 and with the one or more intermediate mast extensions 130, which one or more intermediate mast extensions 130 are also slidably engageable with the lower mast 24. In the embodiment of the Lift Truck Tent Hoist Attachment 10 shown in FIG. 9, the upper mast 90 and intermediate mast extension 130 are shown in their stowed positions.

In order to assemble the one or more intermediate mast extensions 130 and/or the upper mast 90 to the lower mast 24 of the Lift Truck Tent Hoist Attachment 10, the lower mast 24 may again be pivoted about the pivot hinge pin 28 of the lower mast pivot hinge 26 to a generally horizontal position. Once the lower mast 24 is in the generally horizontal position, any intermediate mast extension 130 to be used may be slidably engaged with the lower mast 24 so that the extension insert 132 slides into the lower mast 24 until the lower mast retainer pin hole 36 and the extension retainer pin hole 134 overlap, and a lower mast retainer pin 38 (not shown in FIG. 9) is inserted therein. The upper mast 90 may then be slidably engaged with the intermediate mast extension 130, or with the lower mast 24 if no intermediate mast extension 130 is to be used. The upper mast retainer pin hole 100 (not shown in FIG. 9) then overlaps another extension retainer pin hole 134, or the lower mast retainer pin hole 36 as applicable, and an extension retainer pin 136 (not shown in FIG. 9) is inserted therein.

In order to assist with raising the assembled lower mast 24, upper mast 90, and any intermediate mast extensions 130, a welded hook 56 may again be attached to the lower mast brace assembly 50. The lower mast 24 may again be provided with power cord cleats 32 to facilitate storage of any power and/or remote controller cords. The base 20 may further be provided with a battery box 60 to provide electrical power for the hoist 110. Shackles or cleaves 80 may be attached to the corners of the base 20, so that a chain 82 may be used to secure the Lift Truck Tent Hoist Attachment 10 to a forklift or other equipment having forks.

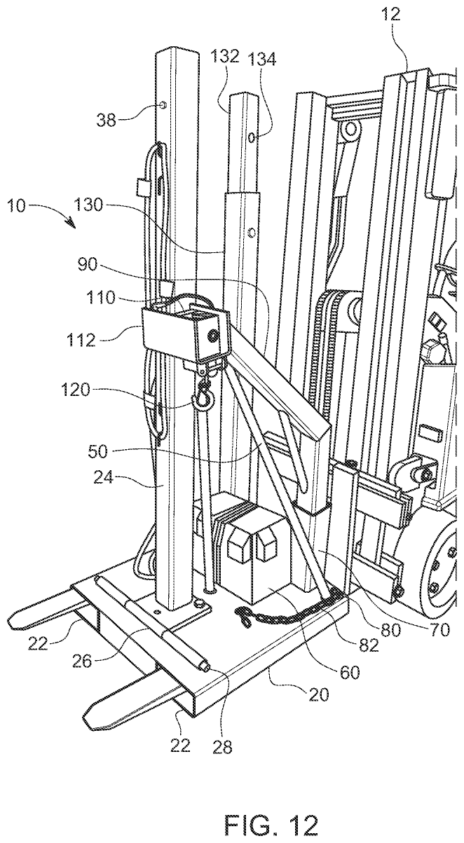

Turning now to FIG. 10, an embodiment of the Lift Truck Tent Hoist Attachment 10 is shown attached to a forklift 12, so that the forks of the forklift 12 are inserted in the fork pockets 22 of the base 20. The Lift Truck Tent Hoist Attachment 10 is securely retained to the forklift 12 using a chain 82 attached to the shackles or cleaves 80. The lower mast 24 is in the vertical position with the lower mast 24 engaged to the receiver 52 of the lower mast brace assembly 50, and retained thereto using a brace pin 54. No intermediate mast extension 130 is in use, so that the upper mast 90 is directly slidably engaged with the lower mast 24 up to the stop ledge 92. A lower mast retainer pin 38 passes through the lower mast retainer pin hole 36 (not visible) and upper mast retainer pin hole 100 (not visible), thereby securely retaining the upper mast 90 to the lower mast 24.

The upper mast 90 is again provided with a dogleg 94 and dogleg brace 96, so that the hoist mount 98 is extended forward of the base 20 of the Lift Truck Tent Hoist Attachment 10. The hoist 110 is again attached to the hoist mount 98, and may be adjoined or encompassed by a hoist guard 112 for protection. The hoist 110 is again electrically connected to the battery box 60, so that the hoist 110, the hoist cable 114 (not visible), and jay hook 120 may be used to raise lightweight loads such as the rafters or simple trusses shown.

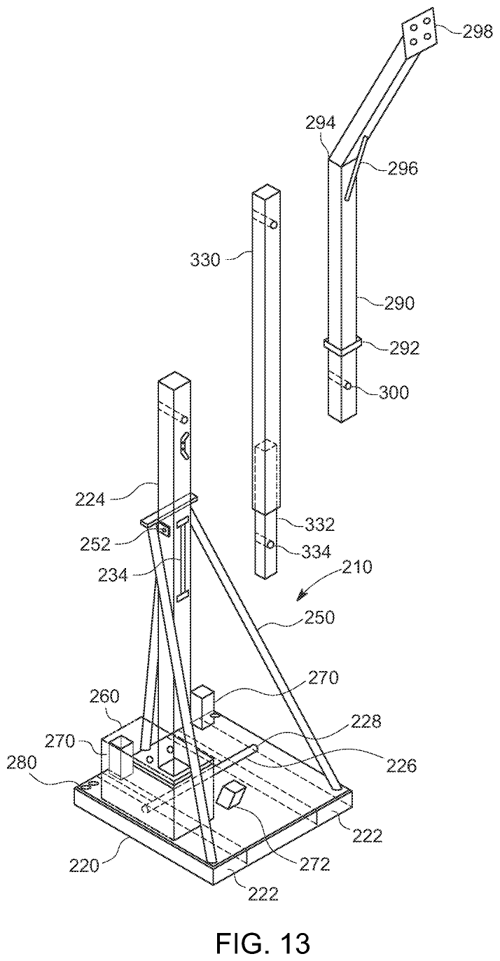

FIG. 11 shows a partial perspective view of an embodiment of the Lift Truck Tent Hoist Attachment 10 attached to a forklift 12. A chain 82 is connected to a shackle or cleave 80, which is in turn attached to the base 20. The chain 82 is shown laying on the base 20 in preparation for use. In use, the chain 82 will be wrapped around the forks and other structure of the forklift 12, in order to securely retain the Lift Truck Tent Hoist Attachment 10 thereto. Also visible in FIG. 11 is an intermediate mast extension 130 in its storage position, and the battery box 60.

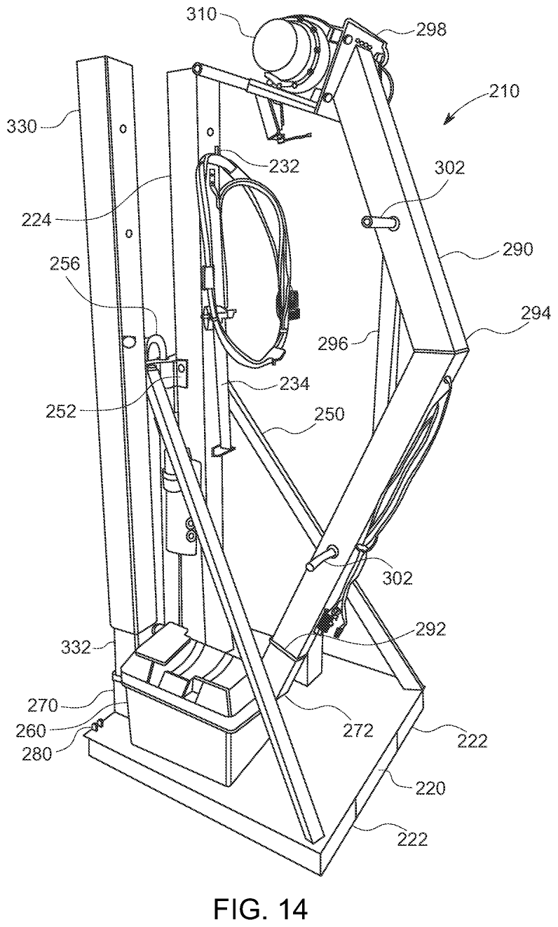

Turning now to FIG. 12, an embodiment of the Lift Truck Tent Hoist Attachment 10 is again shown having a base 20 and a lower mast 24 connected to the base 20 by way of a lower mast pivot hinge 26. The base 20 is again provided with two fork pockets 22 shown engaging the forks of a forklift 12. The base 20 is further provided with a lower mast brace assembly 50 having a receiver 52 (not visible in FIG. 12). When the lower mast 24 is in its vertical position, it engages with the receiver 52 and is held in place by a brace pin 54 (not visible in FIG. 12). The Lift Truck Tent Hoist Attachment 10 also has an upper mast 90 and one or more intermediate mast extensions 130. The upper mast 90 is slidably engageable with the lower mast 24 and with the one or more intermediate mast extensions 130, which one or more intermediate mast extensions 130 are also slidably engageable with the lower mast 24.

In order to assemble the one or more intermediate mast extensions 130 and/or the upper mast 90 to the lower mast 24 of the Lift Truck Tent Hoist Attachment 10, the lower mast 24 may be pivoted about the pivot hinge pin 28 of the louver mast pivot hinge 26 to a generally horizontal position. To facilitate this, the lower mast 24 may be provided with a lower mast handle 30 (not shown in FIG. 12). Further, a kick stand 34 (not visible in FIG. 12) may be attached to the lower mast 24, in order to hold the lower mast 24 up from the ground and in the generally horizontal position. Once the lower mast 24 is in the generally horizontal position, any intermediate mast extension 130 to be used may be slidably engaged with the lower mast 24 so that the extension insert 132 slides into the lower mast 24 until the lower mast retainer pin hole 36 (not visible in FIG. 12) and the extension retainer pin hole 134 overlap, and a lower mast retainer pin 38 is inserted therein. The upper mast 90 may then be slidably engaged with the intermediate mast extension 130, or with the lower mast 24 if no intermediate mast extension 130 is to be used, until the stop ledge 92 (not visible in FIG. 12) abuts the upper end of the intermediate mast extension 130 or upper end of the lower mast 24 as applicable. The upper mast retainer pin hole 100 (not visible in FIG. 12) then overlaps another extension retainer pin hole 134, or the lower mast retainer pin hole 36 (not visible in FIG. 12) as applicable, and an extension retainer pin 136 (not shown in FIG. 12) is inserted therein.

The upper mast 90 is provided with a hoist 110 protected by a hoist guard 112 at the upper end of the upper mast 90. The hoist 110 is provided with a hoist cable 114 (not visible in FIG. 12) and jay hook 120 for lifting. The base 20 may further be provided with a battery box 60 to provide electrical power for the hoist 110. Shackles or cleaves 80 may be attached to the corners of the base 20, so that a chain 82 may be used to secure the Lift Truck Tent Hoist Attachment 10 to the forklift 12. Finally, extension holders 70 may be attached to the base 20 for the purpose of holding the upper mast 90 and any intermediate mast extensions 130 during transport or storage, as illustrated in FIG. 12.

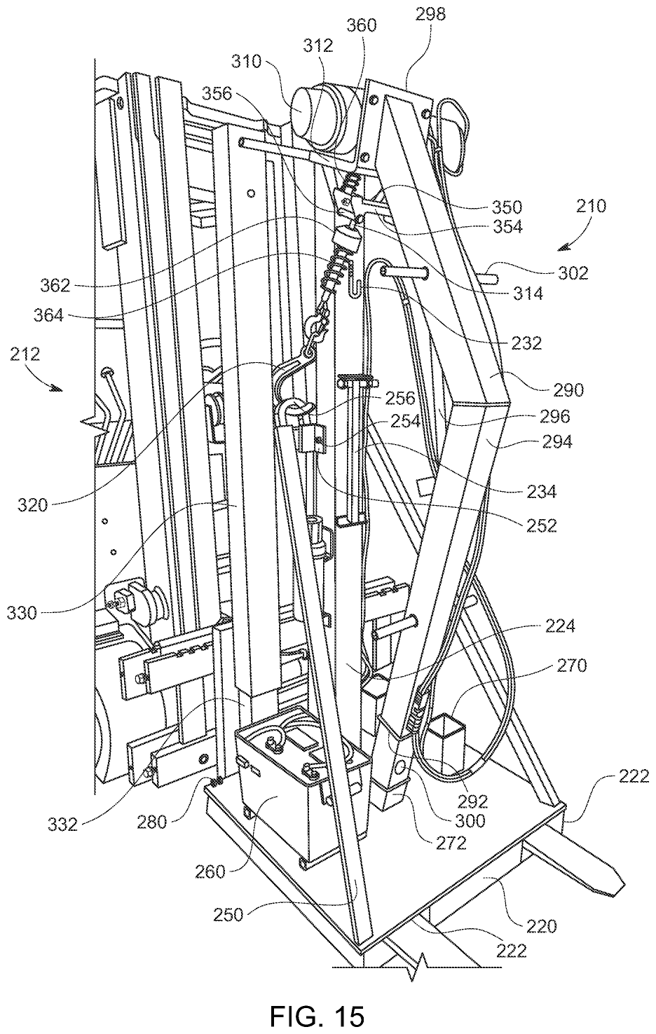

Turning now to FIGS. 13 and 14, a second embodiment of the Lift Truck Tent Hoist Attachment 210 is shown having a base 220 and a lower mast 224 connected to the base 220 by way of a lower mast pivot hinge 226. The base 220 is provided with two fork pockets 222 configured to receive the forks of a forklift (not shown) or other equipment having forks. The base 220 is further provided with a lower mast brace assembly 250 having a receiver 252. The lower mast brace assembly 250 is arranged so that at least one support strut is oriented generally vertical and proximate to the lower mast, and so that at least one support strut is oriented at an angle extending forward from the receiver 252. When the lower mast 224 is in its vertical position, it engages with the receiver 252 and is held in place by a brace pin (not shown). The Lift Truck Tent Hoist Attachment 210 also has an upper mast 290 and one or more intermediate mast extensions 330. The upper mast 290 is slidably engageable with the lower mast 224 and with the one or more intermediate mast extensions 330, which one or more intermediate mast extensions 330 are also slidably engageable with the lower mast 224. The lower mast 224 and the intermediate mast extensions 330 may for non-limiting example be made from 4″×4″× 3/16″ square steel tubing. The upper mast 290 may for non-limiting example be made from 3½″×3 3/16″ square steel tubing.

In order to assemble the one or more intermediate mast extensions 330 and/or the upper mast 290 to the lower mast 224 of the Lift Truck Tent Hoist Attachment 210, the lower mast 224 may be pivoted about the pivot hinge pin 228 of the lower mast pivot hinge 226 to a generally horizontal position. To facilitate this, the lower mast 224 may be provided with a lower mast handle (not shown). Further, a kick stand 234 may be attached to the lower mast 224, in order to hold the lower mast 224 up from the ground and in the generally horizontal position. Once the lower mast 224 is in the generally horizontal position, any intermediate mast extension 330 to be used may be slidably engaged with the lower mast 224 so that an extension insert 332 slides into the lower mast 224 until a lower mast retainer pin hole (not shown) and the extension retainer pin hole 334 overlap, and a lower mast retainer pin (not shown) is inserted therein. The extension insert 332 may therefore be, for non-limiting example, made from 3½″×3½×12″ long square steel tubing. The upper mast 290 may then be slidably engaged with the intermediate mast extension 330, or with the lower mast 224 if no intermediate mast extension 330 is to be used, until a stop ledge 292 abuts the upper end of the intermediate mast extension 330 or upper end of the lower mast 224 as applicable. An upper mast retainer pin hole (not shown) then overlaps another extension retainer pin hole 334, or the lower mast retainer pin hole as applicable, and an extension retainer pin (not shown) is inserted therein.

The upper mast 290 is provided with a dogleg 294, a dogleg brace 296, and a hoist mount 298 at the upper end of the upper mast 290. A hoist 310 is attached to the hoist mount 298, and may be protected by a hoist guard (not shown). The hoist 310 is provided with a hoist cable (not shown) and jay hook (not shown) for lifting. The hoist 310 may further be provided with a high limit switch (not shown) to prevent over-retraction of the hoist cable, and a crane scale or overload alarm (not shown) to notify an operator of a weight overload condition. In order to raise the assembled lower mast 224, upper mast 290, and any intermediate mast extensions 330, a welded hook 256 may be attached to the lower mast brace assembly 250. In use, the jay hook may be engaged to the welded hook 256, and the hoist 310 may then be used to pull the assembled lower mast 224, upper mast 290, and any intermediate mast extensions 330 to the vertical position. The, arrangement of the welded hook 256 being attached to the lower mast brace assembly 250 proximate to the receiver 252, and of the dogleg 294 in the upper mast 290 offsetting the hoist 310 from the centerline of the lower mast 224, again facilitates the use of the hoist 310 to pull the assembled lower mast 224, upper mast 290, and any intermediate mast extensions 330 to the vertical position.

The lower mast 224 may further be provided with one or more power cord cleats 232 to facilitate storage of any power and/or remote controller cords. The base 220 may further be provided with a battery box 260 to provide electrical power for the hoist 310. Alternately, or in conjunction therewith, electrical power for the hoist may be provided by a connection (not shown) with the lift truck electrical system. Shackles or cleaves 280 may be attached to the corners of the base 220, so that a chain (not shown) may be used to secure the Lift Truck Tent Hoist Attachment 210 to a forklift or other equipment having forks. Extension holders 270 may be attached to the base 220 for the purpose of holding the intermediate mast extensions 330 during transport or storage. Similarly, a top mast holder 272 may be attached to the base 220 for the purpose of holding the upper mast 290 during transport or storage. In the embodiment of the Lift Truck Tent Hoist Attachment 210 shown in FIGS. 13 and 14, the top mast holder 272 is a 4″×4″× 3/16″ square steel tube that is welded at a 22 degree angle from vertical, so that the upper mast is approximately centered over the base 220. This, and upper mast handles 302, help to facilitate attaching and removing the upper mast 290 to the base 220.

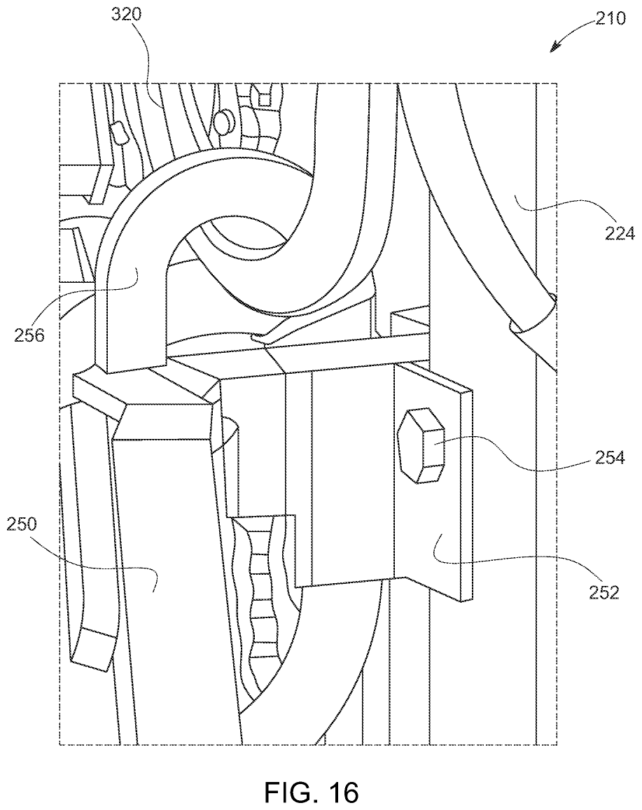

Turning now to FIG. 16, a partial view of the Lift Truck Tent Hoist Attachment 210 is shown. The lower mast 224 is shown attached to the receiver 252 of the lower mast brace assembly 250, to which it is retained by brace pin 254. Jay hook 320 is shown engaged with the welded hook 256, as when the hoist 310 has been used to pull the assembled lower mast 224, upper mast 290, and any intermediate mast extensions 330 to the vertical position.

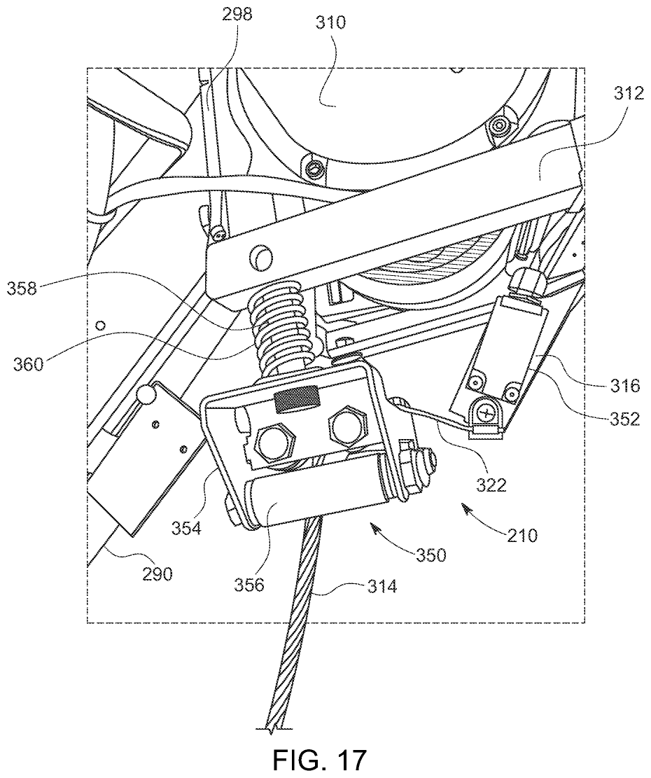

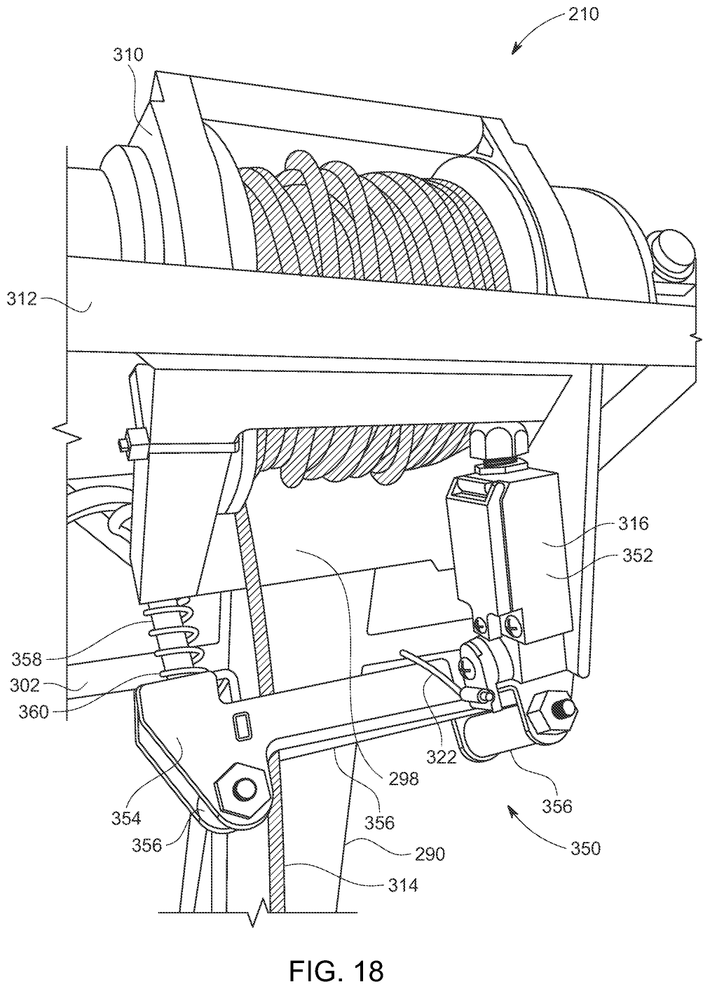

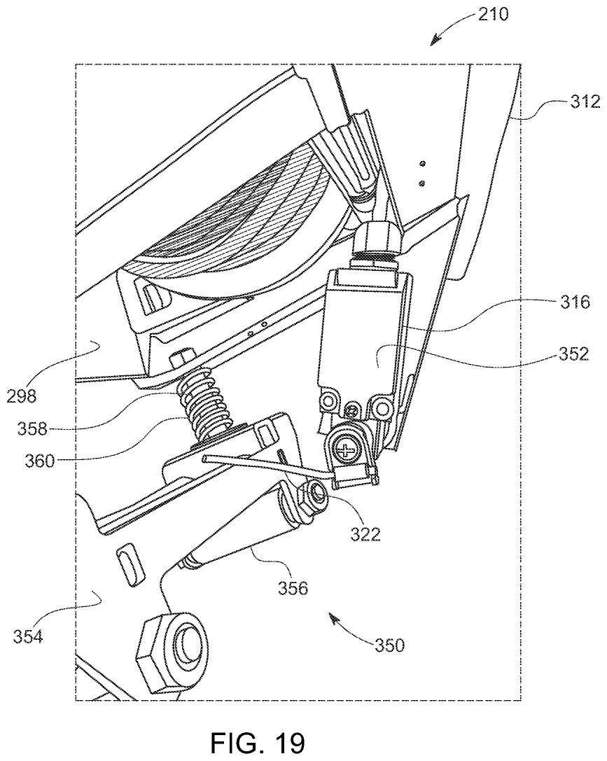

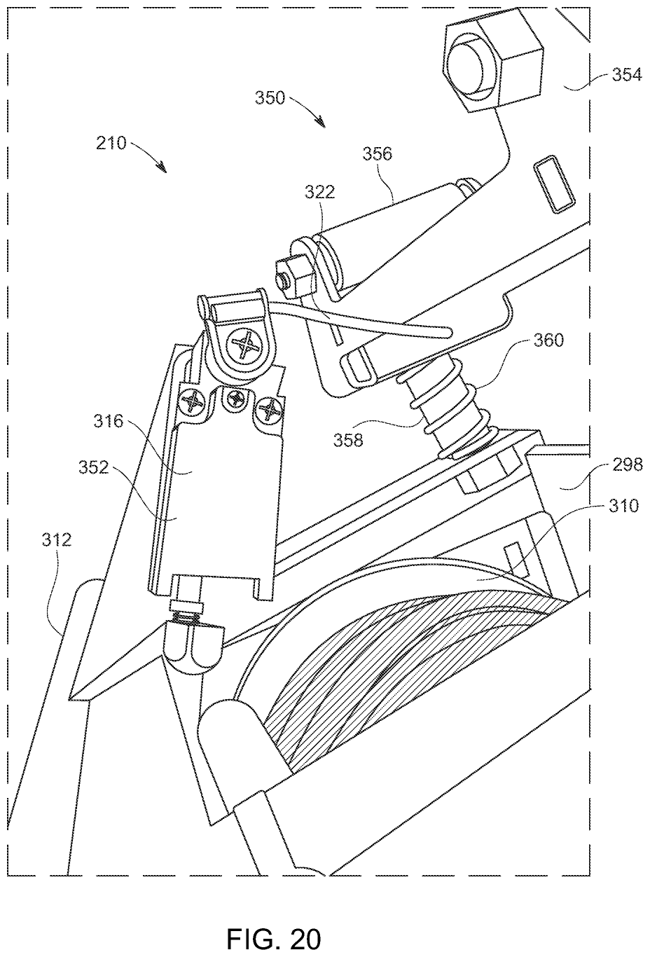

Turning now to FIGS. 17 through 20, another embodiment of the Lift Truck Tent Hoist Attachment 210 is shown. The upper mast 290 of the Lift Truck Tent Hoist Attachment 210 is again provided with a hoist mount 298 to which a hoist 310 is attached. Upper mast handles 302 may be provided to facilitate lifting and attaching the upper mast 290. A hoist guard 312 is attached to the upper mast 290 and/or to the hoist mount 298, and at least partially encompasses or surrounds the hoist 310. A combination limit switch, buffer, and vertical shutoff switch 350 has two fair lead mounting posts 358 attached to the hoist mount 298 and/or to the hoist guard 312. A fair lead assembly 354 is connected to the two fair lead mounting posts 358 by way of holes in the fair lead assembly 354 that go over the two fair lead mounting posts 358, in such a way that the fair lead assembly 354 is able to move up and down vertically over the two fair lead mounting posts 358 in a direction of motion that is approximately tangent to the spool of the hoist 310. Fair lead springs 360 are installed over the two fair lead mounting posts 358 between the hoist mount 298 and/or hoist guard 312 and the fair lead assembly 354. The fair lead springs 360 forcibly bias the fair lead assembly 354 to the distal ends of the fair lead mounting posts 358. The fair lead assembly 354 is prevented from, coming off from the two fair lead mounting posts 358 by bolts having head diameters larger than the holes in the fair lead assembly 354.

A high limit switch 316, which may be a reversing solenoid 352, is attached to the hoist mount 298 and/or to the hoist guard 312 in such a way that the high limit switch 316 is adjacent to the fair lead assembly 354. A high limit switch arm 322 extends from the high limit switch 316 to an upper side of the fair lead assembly 354 proximate to the spool of the hoist 310. The hoist cable 314 passes through the fair lead assembly 354, which is provided with rollers 356 to guide the hoist cable 314 onto the spool of the hoist 310. As noted previously, when the hoist 310 winds up the hoist cable 314, a cable buffer 362 attached to the hoist cable 314 comes into contact with the fair lead assembly 354 at or near the end of travel of the hoist cable 314. The cable buffer 362 will not pass through the fair lead assembly 354, so that the fair lead assembly 354 begins to compress the fair lead springs 360. As the fair lead assembly 354 begins to travel along the fair lead mounting posts 358, the high limit switch arm 322 causes the high limit switch 316 to shut off the hoist 310. Any additional motion of the fair lead assembly 354 is accommodated by further compression of the fair lead springs 360, thereby preventing breakage of the hoist cable 314 or other components of the Lift Truck Tent Hoist Attachment 210. A cable buffer spring 364 may be provided between the cable buffer 362 and the jay hook 320 to accommodate further winding of the spool of the hoist 310 due to lag time of the high limit switch 316 or rotational inertia of the 310.

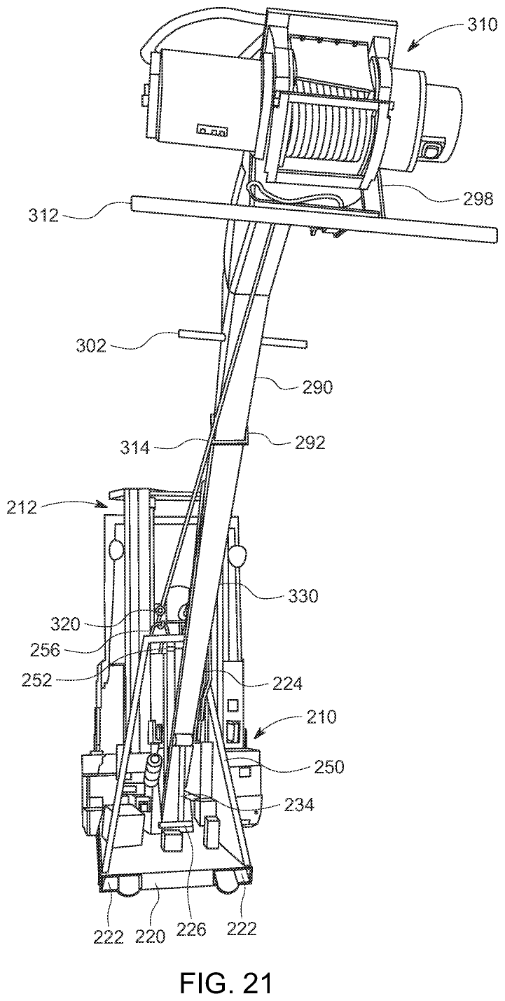

Turning now to FIGS. 15 and 21, the embodiment of the Lift Truck Tent Hoist Attachment 210 shown in FIGS. 13 and 14 is shown attached to a forklift 212. The Lift Truck Tent Hoist Attachment 210 shown in FIGS. 15 and 21 is again provided with a base 220 having fork pockets 222 that engage with the forks of the forklift 212. At least one shackle or cleave 280, preferably two shackles or cleaves 280, one on each rear corner of the base 220, are used in conjunction with a chain (not shown) to retain the Lift Truck Tent Hoist Attachment 210 to the forklift 212. A lower mast 224 is again connected to the base 220 by way of a lower mast pivot hinge 226 having a pivot hinge pin (not shown). The base 220 is again provided with a lower mast brace assembly 250 having a receiver 252. When the lower mast 224 is in its vertical position, it again engages with the receiver 252 and is held in place by a brace pin 254. The lower mast brace assembly 250 is again arranged so that at least one support strut is oriented generally vertical and proximate to the lower mast, and so that at least one support strut is oriented at an angle extending forward from the receiver 252. The Lift Truck Tent Hoist Attachment 210 again has an upper mast 290 and one or more intermediate mast extensions 330. The upper mast 290 is slidably engageable with the lower mast 224 and with the one or more intermediate mast extensions 330, which one or more intermediate mast extensions 330 are also slidably engageable with the lower mast 224.

In order to assemble the one or more intermediate mast extensions 330 and/or the upper mast 290 to the lower mast 224 of the Lift Truck Tent Hoist Attachment 210, the lower mast 224 may again be pivoted about the lower mast pivot hinge 226 to a generally horizontal position. To facilitate this, the lower mast 224 may be provided with a lower mast handle (not shown). Further, a kick stand 234 may be attached to the lower mast 224, in order to hold the lower mast 224 up from the ground and in the generally horizontal position. Once the lower mast 224 is in the generally horizontal position, any intermediate mast extension 330 to be used may be slidably engaged with the lower mast 224 so that an extension insert 332 slides into the lower mast 224 until a lower mast retainer pin hole (not shown) and an extension retainer pin hole (not shown) overlap, and a lower mast retainer pin (not shown) is inserted therein. The upper mast 290 may then be slidably engaged with the intermediate mast extension 330, or with the lower mast 224 if no intermediate mast extension 330 is to be used, until a stop ledge 292 abuts the upper end of the intermediate mast extension 330 or upper end of the lower mast 224 as applicable. An upper mast retainer pin hole 300 then overlaps another extension retainer pin hole, or the lower mast retainer pin hole as applicable, and an extension retainer pin (not shown) is inserted therein. An upper mast handle 302 may be provided to facilitate handling the upper mast 290.

The upper mast 290 is again provided with a dogleg 294, a dogleg brace 296, and a hoist mount 298 at the upper end of the upper mast 290. A hoist 310 is attached to the hoist mount 298, and may be protected by a hoist guard 312. The hoist 310 is provided with a hoist cable 314 and jay hook 320 for lifting. The hoist 310 may further be provided with a high limit switch (not shown) to prevent over-retraction of the hoist cable, and a crane scale or overload alarm (not shown) to notify an operator of a weight overload condition. In order to raise the assembled lower mast 224, upper mast 290, and any intermediate mast extensions 330, a welded hook 256 may be attached to the lower mast brace assembly 250. As illustrated in FIG. 21, the jay hook 320 is engaged to the welded hook 256, and the hoist 310 is being used to pull the assembled lower mast 224, upper mast 290, and intermediate mast extension 330 to the vertical position. The arrangement of the welded hook 256 being attached to the lower mast brace assembly 250 proximate to the receiver 252, and of the dogleg 294 in the upper mast 290 offsetting the hoist 310 from the centerline of the lower mast 224, again facilitates the use of the hoist 310 to pull the assembled lower mast 224, upper mast 290, and the intermediate mast extension 330 to the vertical position.

As before, the lower mast 224 may be provided with one or more power cord cleats 232 to facilitate storage of any power and/or remote controller cords. The base 220 may further be provided with a battery box 260 to provide electrical power for the hoist 310. Extension holders 270 and/or a top mast holder 272 may again be attached to the base 220 for the purpose of holding the intermediate mast extensions 330 and/or the upper mast 290, respectively, during transport or storage.

As with the embodiment of the Lift Truck Tent Hoist Attachment 210 shown in FIGS. 17 through 20, the high limit switch of the embodiment of the Lift Truck Tent Hoist Attachment 210 shown in FIGS. 15 and 21 may be embodied as a combination limit switch, buffer, and vertical shutoff switch 350 having a fair lead assembly 354 movably connected to two fair lead mounting posts (not shown) attached to the hoist mount 298 and/or to the hoist guard 312. Fair lead springs 360 are again installed over the two fair lead mounting posts between the hoist mount 298 and/or hoist guard 312 and the fair lead assembly 354, and forcibly bias the fair lead assembly 354 to the distal ends of the fair lead mounting posts. A reversing solenoid (not shown) is again actuated when the fair lead assembly 354 is pushed along the two fair lead mounting posts towards the hoist mount 298 and/or the hoist guard 312 as the hoist cable 314 is rewound and the cable buffer 362 comes into contact with the fair lead assembly 354, thereby shutting off the hoist 310. A cable buffer spring 364 again provides extra travel to prevent breakage of the hoist cable 314 or other components of the Lift Truck Tent Hoist Attachment 210.

While the Lift Truck Tent Hoist Attachment as been described with respect to at least one embodiment, the Lift Truck Tent Hoist Attachment can be further modified within the spirit and scope of this disclosure, as demonstrated previously. This application is therefore intended to cover any variations, uses, or adaptations of the Lift Truck Tent Hoist Attachment using its general principles. Further, this application is intended to cover such departures from the present disclosure as come within known or customary practice in the art to which the disclosure pertains and which fall within the limits of the appended claims.

### REFERENCE NUMBER LISTING

10/210 Lift Truck Tent Hoist Attachment
12/212 Forklift
20/220 Base
22/222 Fork pocket
24/224 Lower mast
26/226 Lower mast pivot hinge
28/228 Pivot hinge pin
30/230 Lower mast handle
32/232 Power cord cleat
34/234 Kick stand
36/236 Lower mast retainer pin h
38/238 Lower mast retainer pin
50/250 Lower mast brace assembly
52/252 Receiver
54/254 Brace pin
56/256 Welded hook
60/260 Battery Box
70/270 Extension holder
272 Top mast holder
80/280 Shackle or cleave
82/282 Chain
90/290 Upper mast
92/292 Stop ledge
94/294 Dogleg
96/296 Dogleg brace
98/298 Hoist mount
100/300 Upper mast retainer pin hole
302 Upper mast handle
110/310 Hoist
112/312 Hoist guard
114/314 Hoist cable
116/316 High limit switch
118/318 Crane scale/overload alarm
120/320 Jay hook
322 High limit switch arm
130/330 intermediate mast extension
132/332 Extension insert
134/334 Extension retainer pin hole
136/336 Extension retainer pin
350 Combination limit switch, buffer, and vertical shutoff switch
352 Reversing solenoid
354 Fair lead assembly
356 Rollers
358 Fair lead mounting posts
360 Fair lead springs
352 Cable, buffer
364 Cable buffer spring

1. A Lift Truck Hoist Attachment, comprising:
a base having at least one fork pocket;
a lower mast attached to the base by way of a hinge and pivotal between a generally vertical position and a generally horizontal position;
a lower mast brace assembly attached to the base and having a receiver configured to receive the lower mast as it is moved into the generally vertical position, and to retain the lower mast once the lower mast is in the generally vertical position;
an upper mast slidably engageable with and dis-engageable from the lower mast;
a hoist attached to an upper end of the upper mast;
the upper mast having a dogleg that offsets the hoist forward of a centerline of the lower mast; and
a hook attached to the lower mast brace assembly proximate to the receiver;
the hinge, the lower mast brace assembly, the dogleg of the upper mast, and the hook being arranged so that a cable connected to the hoist may be used to pull the lower mast and the upper mast from the generally horizontal position to the generally vertical position.

2. The Lift Truck Hoist Attachment of claim 1, wherein:
the lower mast brace assembly being attached to the base separately from the hinge, the lower mast brace assembly having at least one support strut oriented generally vertically and proximate to the lower mast, and the lower mast brace assembly having at least one support strut oriented at an angle extending rearward from the receiver.

3. The Lift Truck Hoist Attachment of claim 1, wherein:
the lower mast brace assembly being attached to the base separately from the hinge, the lower mast brace assembly having at least one support strut oriented generally vertically and proximate to the lower mast, and the lower mast brace assembly having at least one support strut oriented at an angle extending forward from the receiver.

4. The Lift Truck Hoist Attachment of claim 1, wherein:
the upper mast is slidably engageable with the lower mast to a fixed depth of engagement, the fixed depth engagement being set by a stop ledge affixed to the upper mast.

5. The Lift Truck Hoist Attachment of claim 1, further comprising:
a kickstand connected to the lower mast.

6. The Lift Truck Hoist Attachment of claim 1, further comprising:
at least one intermediate mast extension being slidably engageable with and dis-engageable from the lower mast; and
wherein the upper mast is slidably engageable with and dis-engageable from the at least one intermediate mast extension.

7. The Lift Truck Hoist Attachment of claim 6, further comprising:
at least one extension holder attached to the base and slidably engageable with the upper mast and with the at least one intermediate mast extension.

8. The Lift Truck Hoist Attachment of claim 1, further comprising:
a battery box attached to the base and electrically connected to the hoist.

9. The Lift Truck Hoist Attachment of claim 1, further comprising:
at least one shackle attached to the base; and
at least one chain connected to the at least one shackle and configured to engage to a lift truck or other equipment having forks.

10. A Lift Truck Hoist Attachment, comprising:
a base having at least one fork pocket;
a lower mast attached to the base by way of a hinge and pivotal between a generally vertical position and a generally horizontal position;
a lower mast brace assembly attached to the base and having a receiver configured to receive the lower mast as it is moved into the generally vertical position, and to retain the lower mast once the lower mast is in the generally vertical position;
an upper mast slidably engageable with and dis-engageable from the lower mast;
a hoist attached to an upper end of the upper mast; and
a combination limit switch, buffer, and vertical shutoff switch attached to the upper mast proximate to the upper end of the upper mast and connected to the hoist.

11. The Lift Truck Hoist Attachment of claim 10, wherein:
the combination limit switch, buffer, and vertical shutoff switch further comprises:
a fair lead assembly that is attached to the upper end of the upper mast by way of at least one fair lead mounting post, the fair lead assembly being configured to travel up and down along the at least one fair lead mounting post in a direction approximately tangent to a cable spool of the hoist;
at least one fair lead spring positioned over the at least one fair lead mounting post, the at least one fair lead spring, being arranged to forcibly bias the fair lead assembly toward a distal end of the at least one fair lead mounting post;
a high limit switch having a high limit switch arm configured to be actuated by the fair lead assembly when the fair lead assembly travels upwards along the at least one fair lead mounting post, the high limit switch being configured to switch off the hoist when the high limit switch arm is actuated by the fair lead assembly; and
a cable buffer being attached near the end of a cable of the hoist and being configured to engage the fair lead assembly when the cable of the hoist is nearly rewound, and upon engagement to cause the fair lead assembly to travel upwards along the at least one fair lead mounting post as the hoist further winds the cable.

12. The Lift Truck Hoist Attachment of claim 11, wherein:
the high limit switch further comprises a reversing solenoid.

13. The Lift Truck Hoist Attachment of claim 12, wherein:
the reversing solenoid being operable to reverse the hoist momentarily when the high limit switch arm is actuated by the fair lead assembly, thereby decompressing the at least one fair lead spring.

14. The Lift Truck Hoist Attachment of claim 12, wherein:
the reversing solenoid being between 250 amps and 500 amps in capacity.

15. The Lift Truck Hoist Attachment of claim 11, wherein:
the fair lead assembly is further configured to rock forward and rearward on the at least one fair lead mounting post by way of clearance between the fair lead assembly and the at least one fair lead mounting post; and
the high limit switch arm is further configured to be actuated when the fair lead assembly rocks due to the cable being between about 20 and about 30 degrees from vertical.

15. The Lift Truck Hoist Attachment of claim 1, further comprising:
a cable buffer spring arranged over the cable of the hoist between the cable buffer and the terminus of the cable.

17. The Lift Truck Hoist Attachment of claim 16, wherein:
the at least one fair lead spring being a 300 pounds per inch, 3″ coil spring; and
the cable buffer spring being at least 700 pounds per inch coil spring.

18. The Lift Truck Hoist Attachment of claim 10, wherein:
the upper mast having a dogleg that offsets the hoist forward of a centerline of the lower mast;
a hook is attached to the lower mast brace assembly proximate to the receiver; and
the hinge, the lower mast brace assembly, the dogleg of the upper mast, and the welded hook being arranged so that a cable connected to the hoist may be used to pull the lower mast and the upper mast from the generally horizontal position to the generally vertical position.

19. A combination limit switch, buffer, and vertical shutoff switch for use with a hoist, comprising:
a fair lead assembly that is attached to a mounting surface by way of at least one fair lead mounting post, the fair lead assembly being configured to travel up and down along the at least one fair lead mounting post in a direction approximately tangent to a cable spool of the hoist;
at east one fair lead spring positioned over the at least one fair lead mounting post, the at least one fair lead spring being arranged to forcibly bias the fair lead assembly toward a distal end of the at least one fair lead mounting post;
a high limit switch having a high limit switch arm configured to be actuated by the fair lead assembly when the fair lead assembly travels upwards along the at least one fair lead mounting post, the high limit switch being configured to switch off the hoist when the high limit switch arm is actuated by the fair lead assembly; and
a cable buffer being attached near the end of a cable of the hoist and being configured to engage the fair lead assembly when the cable of the hoist is nearly rewound, and upon engagement to cause the fair lead assembly to travel upwards along the at least one fair lead mounting post as the hoist further winds the cable.

20. The combination limit switch, buffer, and vertical shutoff switch of claim 19, wherein:
the high limit switch further comprises a reversing solenoid.

21. The combination limit switch, buffer, and vertical, shutoff switch of claim 20, wherein:
the reversing solenoid being operable to reverse the hoist momentarily when the high limit switch arm is actuated by the fair lead assembly, thereby decompressing the at least one fair lead spring.

22. The combination limit switch, buffer, and vertical shutoff switch of claim 19, wherein:
the fair lead assembly is further configured to rock forward and rearward on the at least one fair lead mounting post by way of clearance between the fair lead assembly and the at least one fair lead mounting post; and
the high limit switch arm is further configured to be actuated when the fair lead assembly rocks due to the cable being between about 20 and about 30 degrees from vertical.
